(19) United States
(12) Patent Application Publication
(10) Pub. No.: US 2003/0020220 A1
(43) Pub. Date: Jan. 30, 2003

(54) Powertrain mount having capacitive displacement sensor

(75) Inventors: Thomas A. Baudendistel, Farmersville, OH (US); Sanjiv G. Tewani, Lebanon, OH (US); Mark W. Long, Bellbrook, OH (US); James E. Dingle, Cincinnati, OH (US); Larry M. Oberdier, Royal Oak, MI (US); David K. Lambert, Sterling Heights, MI (US)

Correspondence Address: DELPHI TECHNOLOGIES, INC., Legal Staff, Mail Code: 482-204-450, 1450 W. Long Lake, P.O. BOX 5052, Troy, MI, 48098, US

(73) Assignee: DELPHI TECHNOLOGIES, INC.

(21) Appl. No.: 09/915,631

(22) Filed: Jul. 26, 2001

(51) Int. Cl. F16M 1/00; F16M 7/00

(52) U.S. Cl. 267/141; 267/136

(57) ABSTRACT

A mount for a powertrain component of a motor vehicle comprises first and second plates, and a controller. The first plate is connected to one of the powertrain component or a frame of the motor vehicle. The second plate is connected to the other of the powertrain component or the frame of the motor vehicle. The controller measures the capacitance between the first plate and the second plate.

### TECHNICAL FIELD OF THE INVENTION

The present invention relates to powertrain mounts for motor vehicles, and more particularly to a powertrain mount having a capacitive displacement sensor.

### BACKGROUND OF THE INVENTION

It is desirable to provide modern vehicles with improved operating smoothness by damping and/or isolating powertrain vibrations of the vehicle. A variety of mount assemblies are presently available to inhibit such engine and transmission vibrations. Many of these mount assemblies combine the advantageous properties of elastomeric materials with hydraulic fluids. A hydraulic mount assembly of this type typically includes a reinforced, hollow rubber body that is closed by a resilient diaphragm so as to form a cavity. This cavity is separated into two chambers by a plate. The chambers are in fluid communication through a relatively large central orifice in the plate. The first or primary chamber is formed between the partition plate and the body. The secondary chamber is formed between the plate and the diaphragm.

Active vibration control has more recently become known in the art. The three basic components of an active vibration isolation system are a motion sensor (e.g. a motion transducer), a processor and a control device. The sensor responds to vibratory motion by converting the vibratory motion into an electrical output signal that is functionally related to a parameter (e.g. displacement, velocity or acceleration) of the experienced motion. An accelerometer, for example, is a type of sensor wherein the output is a function of the acceleration input; the output is typically expressed in terms of voltage per unit of acceleration. The most common processor is a microprocessor that combines A/D conversion and a control signal derivation section. The control device can be any one of a number of electrically controllable devices designed to control damping in the hydraulic mount.

### SUMMARY OF THE INVENTION

The present invention is a mount for a powertrain component of a motor vehicle. The mount comprises first and second plates, and a controller. The first plate is connected to one of the powertrain component or a frame of the motor vehicle. The second plate is connected to the other of the powertrain component or the frame of the motor vehicle. The controller adjusts the damping characteristics of the mount as a function of the capacitance between the first plate and the second plate.

Accordingly, it is an object of the present invention to provide a mount of the type described above which does not restrict movement of the powertrain mount along any of the x-, y-, or z-axes.

Another object of the present invention is to provide a mount of the type described above which determines the vertical displacement of the mount independent of displacement along any other axis.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic cross-sectional view of a powertrain mount according to the present invention in a first position; and

FIG. 2 is a schematic cross-sectional view of the powertrain mount in a second position.

### DETAILED DESCRIPTION OF THE PRESENTLY PREFERRED EMBODIMENTS

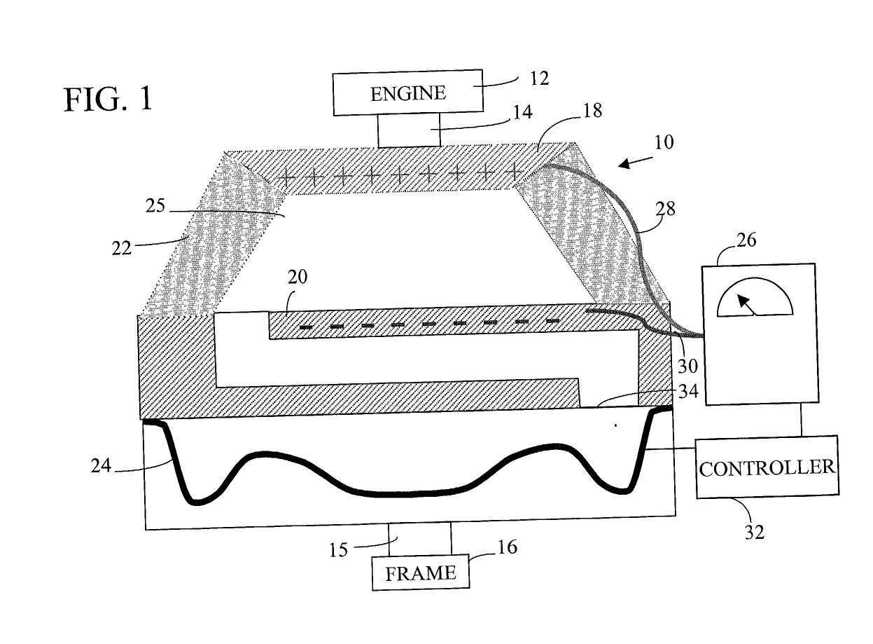

FIG. 1 shows a mount assembly 10 which is attached to an engine 12 or transmission by an electrically insulative fastener 14 such as a stud or the like. The mount assembly 10 is similarly attached to a vehicle frame 16 by an electrically insulative fastener 15 such that the mount is interposed between the engine 12 and the frame member 16. The mount 10 includes a top metal insert or plate 18 and a metal orifice plate 20. A hollow, flexible body 22 generally interconnects the insert 18 and the orifice plate 20. The body 22 can be formed of an elastomeric material, such as natural or synthetic rubber. A diaphragm 24 is attached to the underside of the orifice plate 20 and, together with the body 22, generally defines a chamber 25 for any suitable hydraulic fluid.

A capacitance-to-voltage device 26 is electrically connected to the insert 18 and to the orifice plate 20. In a preferred embodiment, the capacitance-to-voltage device 26 continually applies a small voltage through wires 28 and 30 to positively charge the insert 18 and to negatively charge the orifice plate 20. At the same time, the capacitance-to-voltage device 26 measures the capacitance across the plates 18 and 20, and communicates this information to a system controller 32. Because the plates 18 and 20 essentially form an RC circuit with the capacitance-to-voltage device 26, the plates 18 and 20 can alternatively be periodically charged, and their rate of discharge can be compared with a known curve. Any deviation from this expected curve can then be easily calculated by the controller 32, and the change in capacitance interpreted as vertical displacement of the mount. It should be appreciated that either a direct current or an alternating current can be applied in the present invention.

The controller 32, in turn, is electrically connected to a variable orifice 34 in the orifice plate 20. It should be understood, of course, that the capacitance-to-voltage device can be incorporated, physically or electronically, into the controller 32. Similarly, while the plates 18 and 20 are preferably electrically isolated from ground, one of the plates may be grounded and separate compensating circuitry provided.

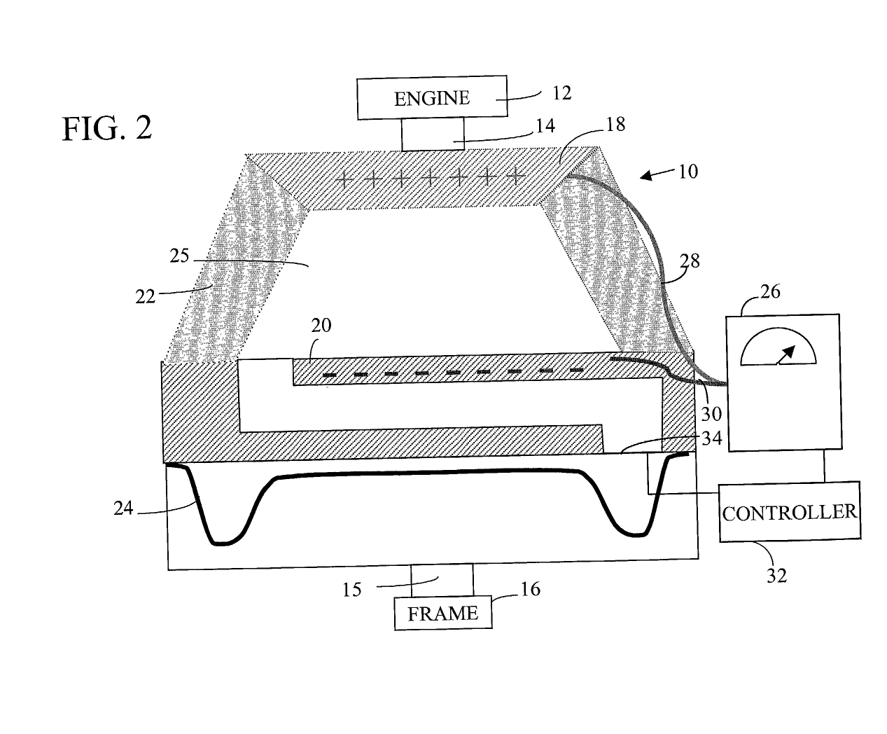

During vehicle operation, engine and transmission vibrations or road impacts subject the insert 18 and the orifice plate 20 to relative displacement. FIG. 2 shows an example of such a displacement. When the insert 18 is vertically displaced relative to the orifice plate 20, the capacitance-to-voltage device 26 measures a change in capacitance between them and communicates this information to the controller 32. In a preferred embodiment, the measured capacitance is inversely proportional to the vertical or x-axis distance between the plates 18 and 20. In response to this the signal from the capacitance-to-voltage device 26, the controller 32 outputs an electrical signal to the variable orifice 34 suitable to alter the damping characteristics of the mount.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A mount for a powertrain component of a motor vehicle, the mount comprising:
a first plate connected to one of the powertrain component or a frame of the motor vehicle;
a second plate connected to the other of the powertrain component or the frame of the motor vehicle; and
means for adjusting damping characteristics of the mount as a function of the capacitance between the first plate and the second plate.

2. The mount of claim 1 wherein the means for adjusting damping characteristics comprises a controller connected to the first and second plates.

3. The mount of claim 1 wherein the means for adjusting damping characteristics comprises a capacitance-to-voltage device connected to the first and second plates.

4. The mount of claim 1 wherein the first plate is fixed relative to the one of the powertrain component or the frame of the motor vehicle.

5. The mount of claim 4 wherein the second plate is fixed relative to the other of the powertrain component or the frame of the motor vehicle.

6. The mount of claim 1 wherein the means for adjusting damping characteristics comprises means for adjusting damping characteristics of the mount as a function of the change in capacitance between the first plate and the second plate.

7. The mount of claim 1 wherein the powertrain component comprises an engine of the motor vehicle.

8. The mount of claim 1 wherein the first plate is positively charged.

9. The mount of claim 1 wherein the second plate is negatively charged.

10. A mount for a powertrain component of a motor vehicle, the mount comprising:
a first plate connected to one of the powertrain component or a frame of the motor vehicle;
a second plate connected to the other of the powertrain component or the frame of the motor vehicle; and
a controller connected to the first plate and to the second plate, the controller generating a signal indicative of the capacitance between the first plate and the second plate.

11. The mount of claim 10 wherein the controller is operative to change damping characteristics of the mount in response to relative movement of the plates.

12. The mount of claim 10 wherein the first plate is fixed relative to the one of the powertrain component or the frame of the motor vehicle.

13. The mount of claim 12 wherein the second plate is fixed relative to the other of the powertrain component or the frame of the motor vehicle.

14. The mount of claim 10 wherein the controller measures the change in capacitance between the first plate and the second plate.

15. The mount of claim 10 further comprising:
a capacitance-to-voltage device connected to the first and second plates and connected to the controller.

16. The mount of claim 10 wherein the powertrain component comprises an engine of the motor vehicle.

17. The mount of claim 10 wherein the first plate is positively charged.

18. The mount of claim 10 wherein the second plate is negatively charged.

19. A system for controlling the damping characteristics of a motor vehicle powertrain mount, the system comprising:
a first, positively charged plate fixed relative to one of the powertrain component or a frame of the motor vehicle;
a second, negatively charged plate fixed relative to the other of the powertrain component or the frame of the motor vehicle; and
a controller connected to the first plate and to the second plate, the controller adjusting the damping characteristics of the mount as a function of the capacitance between the first and second plates.

20. The mount of claim 19 wherein the controller adjusts the damping characteristics of the mounts as a function of the change in capacitance between the first plate and the second plate.
